(19) United States
(12) Patent Application Publication
(10) Pub. No.: US 2010/0225108 A1
(43) Pub. Date: Sep. 9, 2010

(54) CONNECTING ASSEMBLY WITH A FIRST PIPE CONNECTION AND A SECOND PIPE CONNECTION AND A LOCK RING ASSEMBLY FOR A CONNECTING ASSEMBLY OF THIS TYPE

(75) Inventor: Stephan MANN, Biebergemuend (DE)

Correspondence Address: GREENBLUM & BERNSTEIN, P.L.C., 1950 ROLAND CLARKE PLACE, RESTON, VA, 20191, US

(73) Assignee: NORMA GERMANY GMBH, Maintal (DE)

(21) Appl. No.: 12/717,701

(22) Filed: Mar. 4, 2010

(30) Foreign Application Priority Data
Mar. 5, 2009 (DE) 10 2009 011 864.0

(51) Int. Cl. F16L 37/091

(52) U.S. Cl. 285/321

(57) ABSTRACT

Connecting assembly that includes a first pipe connection having a central axis and a second pipe connection having a central axis. The first pipe connection is structured to be insertable into the second pipe connection. A holding rib is located on each of the first and second pipe connections coaxial to the central axes, respectively, and at least one of the holding ribs includes a rear flank arranged to delimit a groove. A lock ring includes a spring strip bent in a generally circular manner through an angle of at least 240° with at least two circumferential ends and projections directed radially inwards. At least one radial surface is positionable against the rear flank of the at least one holding rib, and a spreading element is arranged so that the circumferential ends bear against the spreading element under a spring tension of the spring strip.

### CROSS-REFERENCE TO RELATED APPLICATIONS

The present application claims priority under 35 U.S.C. §119 of German Patent Application No. DE 10 2009 011 864.0, filed on Mar. 5, 2009, the disclosure of which is expressly incorporated by reference herein in its entirety.

### BACKGROUND OF THE INVENTION

1. Field of the Invention

The invention relates to a connecting assembly with a first pipe connection and a second pipe connection, in which the first pipe connection can be inserted into the second pipe connection. The pipe connections are respectively provided with holding ribs coaxial to their central axis and the rear flank of at least one holding rib delimits a groove. A lock ring has a spring strip bent in a largely circular manner by at least 240° with projections directed inwards with radial surfaces, which can be placed against the rear flanks of the holding ribs. The spring strip has two circumferential ends.

Furthermore, the connecting assembly relates to a lock ring assembly for a connecting assembly of this type.

The pipe connections can belong to fluid-holding parts, such as fluid lines and fluid containers, which are to be connected to one another.

2. Discussion of Background Information

A connecting assembly of this type and a lock ring are known from, e.g., EP 1 806 528 A1. The lock ring is preassembled on one of the two pipe connections, and the lock ring is bent open so far that the projections directed radially inwards can be moved over the holding rib on this pipe connection. This pipe connection also has the groove. When the other pipe connection is inserted into the pipe connection with the preassembled lock ring, the lock ring is spread apart by the holding rib of this pipe connection, which expediently has an inclined leading surface. When the holding rib has been pushed through under the projections directed radially inwards, the lock ring snaps together and the two pipe connections are connected to one another in the axial direction and are held in this position by the lock ring. The tightness between the two pipe connections is produced by one or more seals, which are arranged between the two pipe connections.

A connecting assembly of this type has proven to be useful for many uses. The two pipe connections can be connected to one another in a relatively simple manner, namely simply by moving the two pipe connections towards one another in the axial direction and fitting them together.

In producing the connection between the two pipe connections, the fitter must apply a certain force in the axial direction. This force is composed of two components, i.e., a certain force is necessary in order to compress the seal arranged between the two pipe connections, and a force is necessary to spread apart the lock ring, so that it can be guided over the holding rib or, when the lock ring is not preassembled, over the two holding ribs. It is known from experience that a force of more than 80 N is unpleasant to the fitter in the long run. However, this force with the known connecting assembly can be maintained only up to certain nominal widths in the order of magnitude of 35 mm. In the case of greater nominal widths, the force required for installation rises sharply.

### SUMMARY OF THE INVENTION

Embodiments of the invention keep the assembly force low.

According to the embodiments, a connecting assembly of the type mentioned at the outset includes a spreading element arranged between the circumferential ends. The circumferential ends bear against the spreading element under a spring tension of the spring strip.

With embodiments of this type, a part of the force that is required for assembly is taken from the assembly operation. The lock ring is pre-opened, as it were, so that the force necessary to open the lock ring to this open position no longer needs to be applied by the user during the axial insertion of the two pipe connections into one another. The spreading element spreads the lock ring so that, while it is held behind the holding rib of the one pipe connection, the projections directed inwards still protrude a little behind the holding rib. Moreover, because the diameter is limited inwards by the spreading element, the lock ring cannot adopt a smaller diameter. The pipe connections can therefore be axially fitted into one another almost to the end without requiring a further spreading apart of the lock ring. Thus, the force necessary for spreading apart the lock ring is limited to the last section of the movement when fitting the two pipe connections into one another. This force is no longer excessively large either, because the lock ring only has to be spread apart further by a small distance in order to overcome the holding rib. The assembly force as a whole can thus be kept relatively low. When the lock ring has been guided over the holding rib, the spreading element can then be removed.

Preferably, the spreading element has a pull-off protector, which is detachable by action of a holding rib, which in particular has an inclined leading surface. The spreading element additionally has the function of an assembly indicator. The spreading element cannot be removed from the lock ring until the lock ring has reached its final position in which the projections protruding radially inwards are snapped in axially behind the holding ribs. That is, the spreading element cannot be pulled out until the projections have come to rest behind the holding ribs. This is a clear signal to the fitter that the two pipe connections have been correctly connected to one another. This is a great help, especially when the connection of the two pipe connections takes place in a loud environment and the “click” made when the lock ring snaps in behind the holding ribs cannot be heard so clearly.

Preferably, the pull-off protector has at least one spring-mounted finger that is inserted into the spring ring in the radial direction. When the lock ring is in the correct position and the two pipe connections are fitted into one another such that the projections protruding radially inwards on the lock ring have snapped in behind the holding ribs, this finger can be pressed radially outwards against the force of a spring so that it is released from the lock ring. In this case, the spreading element can be pulled off the lock ring.

It may be preferable that the finger has a surface running perpendicular to a pulling direction. The term “perpendicular” should not be understood here in a mathematically exact sense, but rather as a cross direction. In any case, the surface makes it impossible for the spreading element to be removed from the lock ring in the pulling direction. The surface on the finger lies crosswise to the pulling direction and thus provides sufficient resistance to a movement with which the spreading element is to be pulled off the lock ring.

It may be preferable that the surface merges into a further radially inward ramp, which is tilted with respect to the pulling direction. Thus, as soon as the finger has been pressed far enough radially outwards, the ramp interacts with the lock ring so that the spreading element can be pulled off. The further elasticity of the finger radially outwards is then caused by a grade resistance that acts on the ramp when the spreading element is pulled out in the pulling direction.

Preferably, the finger is arranged on a spring arm. This is a relatively simple way of spring-mounting the finger. The spring arm can spring radially outwards when the holding rib acts thereon with a corresponding force. The force can act on the spring arm via the finger.

In a preferred embodiment, however, the spring arm has a release projection protruding radially inwards, which interacts with the holding rib. In particular, when the pipe connections are made of metal, it can be expedient to use an additional release projection. In the case of pipe connections that are made of plastic, it can be sufficient to allow the holding rib to act directly on the finger.

It is preferable that the release projection is axially offset with respect to the finger. In this case, the movement of the finger relative to the snapping in of the respective projections behind the holding rib can be controlled even more precisely. The release projection is then arranged for example in the region of the projections protruding radially inwards on the lock ring. The release projection on the spreading element is expediently displaced axially inwards by the material thickness of the lock ring with respect to the projections protruding radially inwards on the lock ring.

Preferably, the projections have a gap in the region of the finger. The projections protruding radially inwards have a gap anyway so that the lock ring can be bent open. Through the further gap in the region of the finger, for example, the release projection can be arranged in a favorable position.

Preferably, the spreading element has two fingers, which are arranged offset to one another in the circumferential direction in the range of 150° to 210° relative to one another. When two fingers are arranged virtually opposite one another, they can grip the lock ring in a clamping manner, as it were. This further increases the reliability that the spreading element remains on the lock ring.

It may be preferable for the fingers to be arranged symmetrically to the pulling direction. In this way, they can act on the lock ring with the same force so that no tilting forces can occur during pulling.

Preferably, the holding rib has a cylinder surface on its axial end adjacent to the groove. The finger or the release projection can then rest on this cylinder surface without running the risk of sliding off. It is thus ensured with high reliability that the spreading element can be pulled off when the lock ring is in the correct position and is engaged with the projections protruding radially inwards at both axial ends behind the holding ribs.

Preferably, the spreading element has a spacer section, against which the two circumferential ends bear and which has a groove running axially. The spreading element can then additionally be used to ensure a certain angular position of the lock ring with respect to at least one pipe connection. To this end, the pipe connection must then have a projection fitting into the groove.

The invention also relates to a lock ring with a spreading element for a connecting assembly, as described above.

Embodiments of the invention are directed to a connecting assembly that includes a first pipe connection having a central axis and a second pipe connection having a central axis. The first pipe connection is structured to be insertable into the second pipe connection. A holding rib is located on each of the first and second pipe connections coaxial to the central axes, respectively, and at least one of the holding ribs includes a rear flank arranged to delimit a groove. A lock ring includes a spring strip bent in a generally circular manner through an angle of at least 240° with at least two circumferential ends and projections directed radially inwards. At least one radial surface is positionable against the rear flank of the at least one holding rib, and a spreading element is arranged so that the circumferential ends bear against the spreading element under a spring tension of the spring strip.

According to aspects of the invention, the spreading element can include a pull-off protector that is detachable by action of one of the holding ribs. The holding rib may include an inclined leading surface. Further, the pull-off protector can include at least one spring-mounted finger radially insertable into the spring strip.

In accordance with embodiments, the finger may include a surface running crosswise to a pulling direction. Moreover, the finger may further include a ramp surface that merges with the surface and is radially inwardly from the surface. The ramp surface can be oriented at an angle to the pulling direction.

According to further embodiments of the invention, the finger can be arranged on a spring arm. The spring arm may have a release projection protruding radially inwards that is structured and arranged to interact with the one holding rib. The release projection can be axially offset from the finger.

In accordance with other embodiments of the present invention, the projections can have a gap in the region of the finger.

Moreover, the at least one finger can include two fingers, which are offset from one another in a range of 150° to 210° in the circumferential direction. The fingers may be arranged symmetrically to a pulling direction.

According to still other embodiments, the one holding rib can have a cylinder surface on an axial end adjacent to the groove.

In accordance with other embodiments of the invention, the spreading element may include a spacer section having an axially running groove, and the two circumferential ends can bear against the spacer section.

According to embodiments, a lock ring assembly for the above-described connecting assembly can include a spreading element arranged to maintain the spring tension on the circumferential ends.

Embodiments of the invention are directed to a method of connecting a first pipe connection and a second pipe connection. The method includes inserting a portion of the first pipe connection into the second pipe connection, and opening a prestressed lock ring with a rib as the first pipe connection is inserted further into the second pipe connection, the prestressed lock ring having a circular shape through an angle of about 240° and circumferential ends held open against a spring force. The lock ring is prestressed before being opened with the rib.

In accordance with still yet further features of the embodiments of the present invention, a spreading element can be arranged to hold the circumferential ends open against the spring force. The spreading element can further include a pull-off protector, and the method may further include removing the pull-off protector when a projection of the lock ring is located in a groove delimited by a rear flank of the rib.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 illustrates a connecting assembly with a first pipe connection and a second pipe connection;

FIG. 2 illustrates a lock ring with a spreading element;

FIG. 3 illustrates the spreading element from a first viewing angle;

FIG. 4 illustrates the spreading element from a second viewing angle;

FIG. 5 illustrates a second embodiment of a spreading element in perspective representation; and

FIG. 6 illustrates a view from the front of the spreading element according to FIG. 5.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

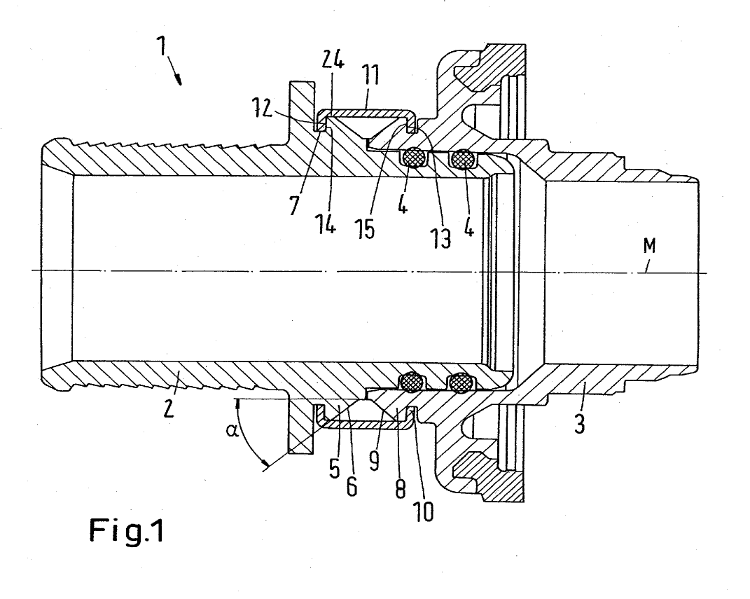

FIG. 1 shows a connecting assembly 1 with a first pipe connection 2 and a second pipe connection 3. First pipe connection 2 is insertable into second pipe connection 3 in the manner shown in FIG. 1. Seals 4 seal a transition between first pipe connection 2 and second pipe connection 3.

The two pipe connections 2 and 3 have a common central axis M. First pipe connection 2 has a full perimeter holding rib 5, which has an inclined leading surface 6 on its side facing towards second pipe connection 3. On the side of holding rib 5 lying opposite inclined leading surface 6, a groove 7 is delimited.

In a similar manner, second pipe connection 3 has a holding rib 8, which is provided on a side facing towards first pipe connection 2 with an inclined leading surface 9 and which delimits a groove 10 on its side facing away from the inclined leading surface 9.

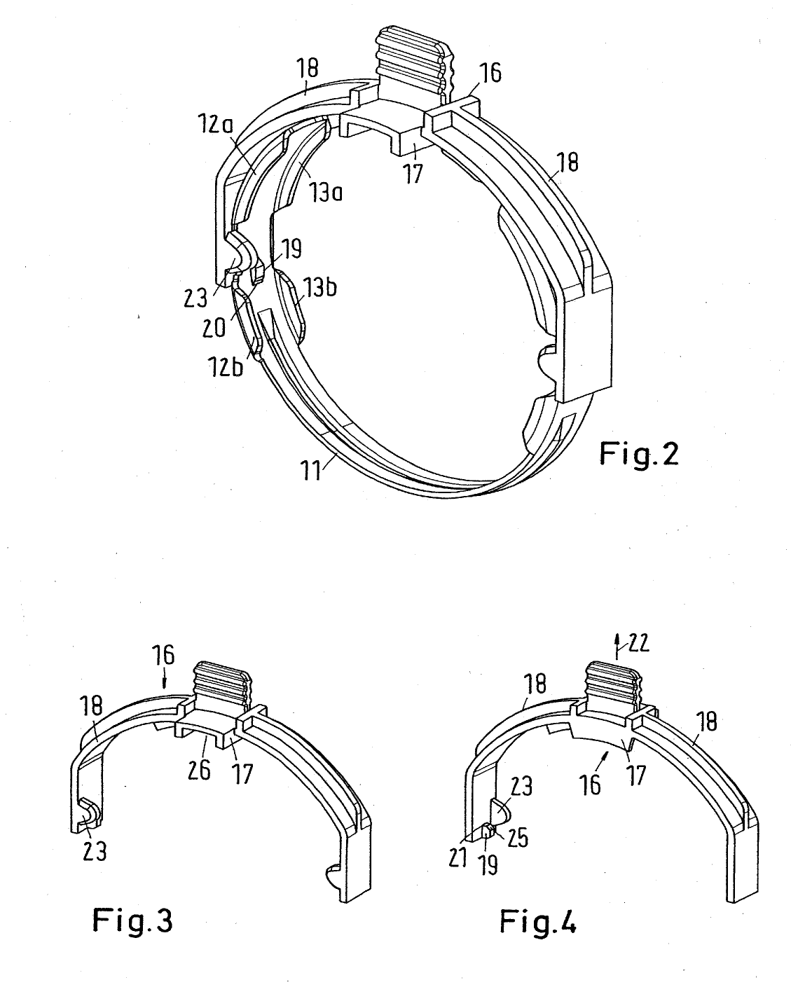

A lock ring 11, which is made from an elastic material, e.g., a metal, such as steel, is embodied or formed as a spring strip (see FIG. 2), which is bent in a circular manner over at least 240°. The circular form does not need to be achieved in the mathematically exact sense thereby. Lock ring 11 has projections 12 and 13 directed radially inwards, which, with radial surfaces 14 and 15 bear, against the rear flanks of the holding ribs 5 and 8 when the connecting assembly is produced as shown in FIG. 1. Projections 12 and 13 ensure against the two pipe connections 2 and 3 being pulled apart from one another in the axial direction.

When first pipe connection 2 is inserted into second pipe connection 3, seals 4 must be somewhat compressed and lock ring 11, which is preassembled on, e.g., second pipe connection 3, must be spread apart by inclined leading surface 6. Inclined leading surface 6 can be oriented to form an angle a to central axis M, so that radially inward protruding projection 12 can slide over holding rib 5 and then snap into groove 7. A certain force is necessary for both actions, which can substantially exceed a desired force of 80 N in the case of larger nominal widths. For this reason, i.e., to reduce the required connection force, a spreading element 16, which is illustrated in FIG. 2, has a spacer section 17 arranged so that the two circumferential ends of lock ring 11 bear against it. Spreading element 16 presses the two circumferential ends of lock ring 11 apart somewhat and thus enlarges the inner diameter of lock ring 11. The increase in diameter is only large enough, however, for lock ring 11 to still be held securely behind holding rib 8 on second pipe connection 3. As can be seen from FIG. 2, projections 13, which dip into groove 10, are arranged so that they secure lock ring 11 in at least three (3) positions in groove 10 in the circumferential direction of pipe connection 3, even when lock ring 11 has been somewhat enlarged. Lock ring 11 is thus securely held on second pipe connection 3 even in the spread apart (pre-connection) state.

Spreading element 16 has two spring arms 18 that extend from spacer section 17 in the circumferential direction of lock ring 11. A finger 19, which is arranged to protrude radially inwardly on each spring arm 18, is inserted radially into an opening 20 in lock ring 11. The two fingers 19 are approximately diametrically opposite one another, so that they are spaced apart in the circumferential direction by between 150° to 210°.

Each finger 19 has on its radially outer end a surface 21, which is directed crosswise to a pulling direction 22. As long as finger 19 is inserted in lock ring 11, through which the spring arm 18 is pushed radially inwards, it is not possible to draw spreading element 16 off lock ring 11.

A release projection 23 is arranged on each spring arm 18 to be adjacent to finger 19. As can be seen from FIG. 2, finger 19 as well as release projection 23 are arranged in a hole between two projections 12a, 12b (13a, 13b) protruding radially inwards on lock ring 11. Release projection 23 is thereby axially offset inwards somewhat with respect to projections 12a, 12b on lock ring 11, i.e., in the order of magnitude of the axial thickness of projections 12a, 12b. Release projection 23 protrudes radially somewhat further inwards than projections 12 and 13 on lock ring 11.

When connecting assembly 1 is to be produced according to FIG. 1, expediently lock ring 11 is preassembled with locking element 16 (not shown in FIG. 1) on second pipe connection 3. When first pipe connection 2 is inserted into second pipe connection 3, lock ring 11 has a diameter that needs to be enlarged only slightly to move projection 12 of lock ring 11 over holding rib 5. To this end projection 12 (with its parts 12a, 12b) comes to rest on inclined leading surface 6 only at a relatively late section of the movement. Since lock ring 11 needs to be expanded only slightly, only a relatively small force, which can be easily applied by the fitter, is necessary for this slight expansion. When first pipe connection 2 has been pushed far enough into second pipe connection 3, projections 12 could theoretically snap into groove 7 on the rear of holding rib 5. However, this is possible only to a limited extent, because lock ring 11 is still held at its enlarged diameter by spreading element 16. However, at this point in time, release projection 23 bears against a cylinder surface 24 of holding rib 5, which is adjacent to groove 7. Spring arms 18 are thereby spread radially outwards and fingers 19 are released from openings 20 of lock ring 11. In a preferred embodiment, fingers 19 are moved completely out of the spring strip of lock ring 11. However, this is not absolutely necessary when a ramp 25 adjoins surface 21 running crosswise to the pulling direction 22. This ramp 25 forms an acute angle with pulling direction 22, so that with a movement of spreading element 16 in pulling direction 22, ramp 25 can also be used to spread spring arms 18 radially outwards in order to fully release fingers 19 from lock ring 11.

Spacer section 17 has a groove 26 running axially. Groove 26 can be used to position lock ring 11 with a predetermined angular alignment to first pipe connection 2. For this purpose, first pipe connection 2 needs to have only one projection (not shown) running axially, which fits into groove 26.

A spreading element 16 with release projections 23 is preferably used when the two pipe connections 2 and 3 or at least first pipe connection 2 are made of a metal.

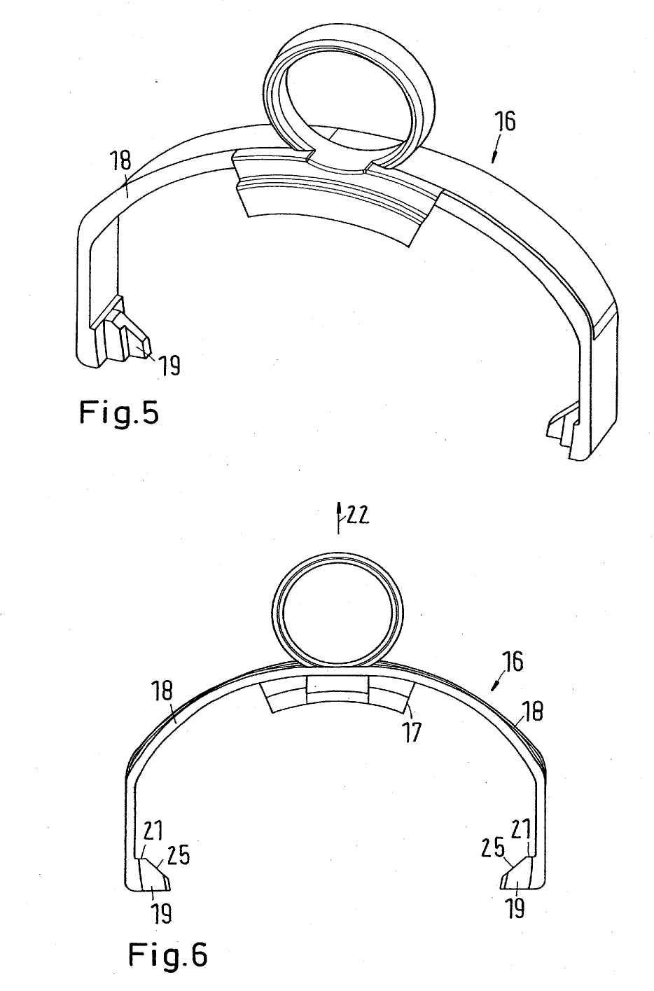

FIGS. 5 and 6 show a modified form of a spreading element 16, in which the same and corresponding parts as in FIGS. 1 through 4 are provided with the same reference numbers.

In this embodiment, fingers 19 are again arranged at the ends of spring arms 18, and these fingers engage in corresponding openings 20 in lock ring 11. Fingers 19 also have a surface 21, which is directed crosswise to pulling direction 22. Ramp 25 adjoins this surface. However, fingers 19 themselves are used to press spring arms 18 apart in the radial direction, when first pipe connection 2 is placed into second pipe connection 3. For this purpose, fingers 19 protrude radially inwards somewhat further than with the embodiment according to FIGS. 2 through 4 so that they come to rest in inclined leading surface 6 of holding rib 5 and are spread apart with a further movement of first pipe connection 2 into second pipe connection 3. When projections 12 have then snapped into groove 7 and the two circumferential ends of lock ring 11 have come to rest again on spacer section 17, the spring strip of lock ring 11 is released from surfaces 21 and reaches ramp 25. Through a pulling movement in pulling direction 22, the grade resistance then acting on ramp 25 causes spring arms 18 to be spread further apart and fingers 19 to be released from lock ring 11.

An embodiment of this type is preferably used when at least the first pipe connection 2 is made of a plastic material.

With both embodiments, when fitting the two pipe connections 2 and 3 together, the fitter will notice when lock ring 11 with its projections 12 snaps into groove 7. Further, he can be sure that the snapping-in has occurred as desired when he can draw spreading element 16 off lock ring 11. If spreading element cannot be drawn off lock ring 11, the fitter knows the two pipe connections 2 and 3 must be axially pushed together again with a certain force.

Spreading apart the spring arms 18 requires only very little additional force, which is virtually unimportant.

Groove 10 on second pipe connection 3 means that lock ring 11 cannot yield in the axial direction when first pipe connection 2 is inserted into second pipe connection 3. For this reason, the groove 10 on the second pipe connection 3 should have an axial extension that corresponds to approximately the thickness of the projections 13.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A connecting assembly comprising:
a first pipe connection having a central axis;
a second pipe connection having a central axis, wherein the first pipe connection is structured to be insertable into the second pipe connection;
a holding rib located on each of the first and second pipe connections coaxial to the central axes, respectively;
at least one of the holding ribs comprising a rear flank arranged to delimit a groove;
a lock ring comprising a spring strip bent in a generally circular manner through an angle of at least 240° with at least two circumferential ends and projections directed radially inwards, wherein at least one radial surface is positionable against the rear flank of the at least one holding rib; and
a spreading element arranged so that the circumferential ends bear against the spreading element under a spring tension of the spring strip.

2. The connecting assembly in accordance with claim 1, wherein the spreading element comprises a pull-off protector that is detachable by action of one of the holding ribs.

3. The connecting assembly in accordance with claim 2, wherein the holding rib comprises an inclined leading surface.

4. The connecting assembly in accordance with claim 2, wherein the pull-off protector comprises at least one spring-mounted finger radially insertable into the spring strip.

5. The connecting assembly in accordance with claim 4, wherein the finger comprises a surface running crosswise to a pulling direction.

6. The connecting assembly in accordance with claim 5, wherein the finger further comprises a ramp surface that merges with the surface and is radially inwardly from the surface.

7. The connecting assembly in accordance with claim 6, wherein the ramp surface is oriented at an angle to the pulling direction.

8. The connecting assembly in accordance with claim 4, wherein the finger is arranged on a spring arm.

9. The connecting assembly in accordance with claim 8, wherein the spring arm has a release projection protruding radially inwards that is structured and arranged to interact with the one holding rib.

10. The connecting assembly in accordance with claim 9, wherein the release projection is axially offset from the finger.

11. The connecting assembly in accordance with claim 4, wherein the projections have a gap in the region of the finger.

12. The connecting assembly in accordance with claim 4, wherein the at least one finger comprises two fingers, which are offset from one another in a range of 150° to 210° in the circumferential direction.

13. The connecting assembly in accordance with claim 12, wherein the fingers are arranged symmetrically to a pulling direction.

14. The connecting assembly in accordance with claim 1, wherein the one holding rib has a cylinder surface on an axial end adjacent to the groove.

15. The connecting assembly in accordance with claim 1, wherein the spreading element comprises a spacer section having an axially running groove, and wherein the two circumferential ends bear against the spacer section.

16. A lock ring assembly for the connecting assembly in accordance with claim 1 comprising a spreading element arranged to maintain the spring tension on the circumferential ends.

17. A method of connecting a first pipe connection and a second pipe connection, comprising:
inserting a portion of the first pipe connection into the second pipe connection;
opening a prestressed lock ring with a rib as the first pipe connection is inserted further into the second pipe connection, the prestressed lock ring having a circular shape through an angle of about 240° and circumferential ends held open against a spring force,
wherein the lock ring is prestressed before being opened with the rib.

18. The method in accordance with claim 17, wherein a spreading element is arranged to hold the circumferential ends open against the spring force.

19. The method in accordance with claim 18, wherein the spreading element further comprises a pull-off protector, and the method further comprises removing the pull-off protector when a projection of the lock ring is located in a groove delimited by a rear flank of the rib.
